(19) United States
(12) Patent Application Publication
(10) Pub. No.: US 2026/0205198 A1
(43) Pub. Date: Jul. 16, 2026

(54) SYMMETRIC OPTICAL SIGNAL REPEATER

(71) Applicant: TEKNOLOGIAN TUTKIMUSKESKUS VTT OY, Espoo (FI)

(72) Inventors: Thomas FORDELL, Espoo (FI); Anders WALLIN, Espoo (FI); Kalle HANHIJÄRVI, Espoo (FI); Thomas LINDVALL, Espoo (FI)

(21) Appl. No.: 19/133,874

(22) PCT Filed: Nov. 29, 2023
(86) PCT No.: PCT/FI2023/050654

§ 371 Date: May 29, 2025

(30) Foreign Application Priority Data
Nov. 30, 2022 (FI) 20226064

(51) Int. Cl. H04B 10/29; H04B 10/25; H04B 10/50

(52) U.S. Cl. CPC H04B 10/29; H04B 10/2589; H04B 10/503

(57) ABSTRACT

An optical signal repeater where an upstream modulator is configured to generate an optical upstream output signal by modulating an optical carrier signal, and to transmit the optical upstream output signal to an upstream fibre-optic output port. A downstream modulator is also configured to generate an optical downstream output signal by modulating an optical carrier signal and to transmit the optical downstream output signal to a downstream fibre-optic output port. By ensuring that the wavelengths of the optical carrier signals are equal or substantially equal, the wavelength drift in the upstream direction can be kept equal to the drift in the downstream direction. These repeaters can be used for time and frequency synchronization in long-distance fibre-optic networks.

### FIELD OF THE DISCLOSURE

The present disclosure relates to fibre-optic networks, and more particularly to time and frequency synchronization over long distances in such networks. The present disclosure further concerns repeater stations in fibre-optic networks.

### BACKGROUND OF THE DISCLOSURE

Fiber-optic time and frequency transfer can facilitate clock synchronization over long distances. Compared to alternative synchronization means, such as synchronization via global satellite navigation services, fibre-optic synchronization can provide better security against spoofing and jamming as well as better stability and accuracy.

Accurate time and frequency transfer in fibre-optic networks requires symmetric two-way communication between a transmitter (Tx) and a receiver (Rx). Systematic errors can typically be minimized by passing the upstream (transmitter-to-receiver) and downstream (receiver-to-transmitter) synchronization signals through the same fibre-optic cable.

If the transmitter and receiver are distant from each other, communication between them requires a set of bi-directional optical amplifiers installed along the fibre-optic link. Such amplifiers may be called repeater stations, and they may for example comprise optoelectronic signal repeaters where a light sensor converts the incoming optical signal (sent from the previous station) into an electrical signal, and this electrical signal is used to modulate light emitted by a laser toward the next station.

Conventional bi-directional repeater stations may generate asymmetry between the upstream and downstream signals. FIG. 1a illustrates a repeater station 19 known from the prior art. The incoming upstream signal 111 is guided to an upstream light sensor 161 which measures the signal 111 and generates a first control signal 131. An upstream laser 11 emits light toward the next station in the upstream direction. This light is modulated by an upstream modulator 13 which sequentially transmits and blocks the light emitted by upstream laser 11. The modulation sequence is based on the first control signal 131. Similarly, the incoming downstream signal 121 is tracked by a downstream light sensor 162 which generates a second control signal 132 to control a downstream modulator 14 which modulates the light emitted by a downstream laser 12.

However, the light wavelengths emitted by the upstream and downstream lasers 11 and 12 can change due to temperature variations and/or ageing effects. Furthermore, the changes that take place in the upstream laser 11 may differ from those in the downstream laser 12.

Any drift in the transmitted wavelength produces a corresponding drift in timing. The drift may be compounded when multiple repeater stations are connected in series, as FIG. 1b illustrates. Each R-letter represents one repeater station 19. Each wavelength shift is independent of the others. The differences between laser outputs in serially connected repeater stations can therefore generate significant timing asymmetry between the upstream and downstream signals, which leads to synchronization errors.

### BRIEF DESCRIPTION OF THE DISCLOSURE

An object of the present disclosure is to provide an apparatus which overcomes the above problems. The object of the disclosure is achieved by an arrangement which is characterized by what is stated in the independent claim. The preferred embodiments of the disclosure are disclosed in the dependent claims.

The disclosure is based on the idea of ensuring that the light emitted in the upstream direction from a repeater station and the light emitted in the downstream direction from that repeater station have the same wavelength or are always separated by a small, constant wavelength difference. An advantage of this arrangement is that the wavelength drift will be equal in both directions. Timing drift in the repeater stations can thereby be minimized.

### BRIEF DESCRIPTION OF THE DRAWINGS

In the following the disclosure will be described in greater detail by means of preferred embodiments with reference to the accompanying drawings, in which

FIGS. 1a-1b illustrate bidirectional repeaters known from the prior art.

FIGS. 2a-2e illustrate bidirectional repeaters with a single laser device.

FIGS. 3a-3b illustrate bidirectional repeaters with two laser devices.

FIG. 3c illustrates bidirectional repeaters where a first laser device is frequency-locked to a second laser device

### DETAILED DESCRIPTION OF THE DISCLOSURE

This disclosure describes an optical signal repeater. The repeater comprises an upstream fibre-optic input port and an upstream light sensor coupled to the upstream fibre-optic input port. The repeater also comprises a downstream fibre-optic input port and a downstream light sensor coupled to the downstream fibre-optic input port, and a laser system configured to generate an optical carrier signal.

The repeater also comprises an upstream modulator controlled by the upstream light sensor. The upstream modulator is configured to generate an optical upstream output signal by modulating the optical carrier signal, and to transmit the optical upstream output signal to an upstream fibre-optic output port.

The optical signal repeater also comprises a downstream modulator which is controlled by the downstream light sensor. The downstream modulator is configured to generate an optical downstream output signal by modulating the optical carrier signal, and to transmit the optical downstream output signal to a downstream fibre-optic output port.

The terms “upstream” and “downstream” refer in this disclosure to two different directions along the fibre-optic connection where the optical signal repeater is being used. If the connection extends between a transmitter and a receiver, then the upstream direction may for example be the transmitter-to-receiver direction, while the downstream direction may be the receiver-to-transmitter direction. Alternatively, these two directions may simply be designated left-to-right and right-to-left. In the figures of this disclosure, the upstream direction is indicated as left-to-right, while the downstream direction is right-to-left. Any element designated with the word “upstream” refers either to a signal passing from left to right, or to an element in the repeater station which contributes to the repetition of a left-to-right signal. Conversely, any element designated with “downstream” refers either to a signal passing from right to left, or to an element in the repeater station which contributes to the repetition of a right-to-left signal.

The fibre-optic ports may function as both input ports and output ports. Consequently, the upstream fibre-optic input port may be the same port as the downstream fibre-optic output port, and the downstream fibre-optic input port may be the same port as the upstream fibre-optic output port. The ports may in this case be called the first fibre-optic input/output port (on the left) and the second fibre-optic input/output port (on the right).

The first fibre-optic input/output port may receive optical input signals from the left and send optical output signals in the same direction. The second fibre-optic input/output port may receive optical input signals from the right and send optical output signals in the same direction. Beam splitters or any other suitable means for transferring input signals to the light sensors may be connected to fibre-optic input/output ports.

The upstream and downstream signals may propagate through the same optical fibre. The optical signal repeater may in this case be connected to the left through the first fibre-optic input/output port, and to the right through the second fibre-optic input/output port. The fibre-optic ports described in this disclosure may alternatively be called fibre-optic connectors.

Alternatively, the upstream and downstream signals may propagate in the upstream direction through one fibre-optic link and in the downstream direction through another fibre-optic link. In this case the upstream fibre-optic input port and the downstream fibre-optic output port can be two different ports, each connected to a separate optical fibre. Similarly, the upstream fibre-optic output port and the downstream fibre-optic input port can be two different ports connected to separate optical fibres.

The optical signal repeater may be configured to generate the optical upstream output signal and the optical downstream output signal simultaneously. In other words, the upstream modulator may be configured to generate the optical upstream output signal at the same time as the downstream modulator generates the optical downstream output signal.

The optical signal repeater may be configured to generate the optical upstream output signal and the optical downstream output signal continuously. That is, the optical signal repeater may transmit the optical upstream and downstream output signals without pauses.

The optical signal repeater may also be called an optical time and frequency signal repeater. It can be used for transferring a time transfer signal and/or a frequency transfer signal.

The time transfer signal, which may also be called a time signal or a clock signal, may be used for synchronization. The time transfer signal may be a reference signal that provides a precise timing reference for various network components. Synchronization is crucial for example in telecommunications, where it is important that different elements of the network operate in a coordinated and time-aligned manner. The time transfer signal helps maintain accurate timing across the network, allowing for efficient data transmission and reception.

The time transfer signal may be a periodic waveform with well-defined timing intervals. This waveform may be used to synchronize the transmission and reception of data at different points in the network, ensuring that signals arrive and are processed at the correct times. Synchronization helps avoid issues such as data collisions, timing errors, and signal degradation. The time signal may be generated by a clock source in any network node and distributed throughout the network using various synchronization methods.

The frequency transfer signal may, but does not have to, be an intensity-modulated (IM) or phase-modulated (PM) optical frequency signal. The frequency transfer signal may also be called a frequency signal. Frequency transfer signals may be used for frequency synchronization between different components or nodes within a network. In other words, frequency transfer may be concerned with aligning the frequency characteristics of signals transmitted in a network. Frequency stability and accuracy are crucial for effective synchronization in certain communication systems. The frequency transfer signal may carry information about the frequency of a transmitted optical signal.

The term “optical carrier signal” refers in this disclosure to unmodulated light generated in the laser system. In embodiments where the laser system comprises a single laser device, the optical carrier signal simply comprises the light emitted by that single laser device before that light undergoes any modulation. This light has a specific wavelength, which may be referred to as the laser wavelength of the laser device.

In embodiments where the laser system comprises two laser devices, the optical carrier signal comprises light emitted by both of these laser devices. The two laser devices may be configured to always emit light at the same wavelength through injection-locking or frequency-locking.

If the two lasers are frequency-locked to each other, the first laser may alternatively be configured to emit light at a wavelength which is separated from the wavelength emitted by the second laser by a small and constant offset. This offset may for example be less than 1 nm, less than 2 nm or less than 3 nm. The laser wavelength of both laser devices may drift over time due to ageing or variations in temperature, but the drift which takes place in the carrier signal generated by one laser device will still always be equal to the drift which takes place in the carrier signal generated by the other laser device. Consequently, for the purpose of this disclosure the optical carrier signal may in this case be considered to comprise two components (one produced by the first laser device, the other produced by the second laser device) which are separated from each other by a constant wavelength offset. This will be explained in more detail below.

The laser system may comprise a single laser device. The light emitted by the laser system, which constitutes the optical carrier signal, is in this case distributed in two different directions, for example with a beam splitter. A first part of the carrier signal is distributed to the upstream modulator where it is modulated into the optical upstream output signal. A second part of the carrier signal is distributed to the downstream modulator where it is modulated into the optical downstream output signal. The modulation imparted by the upstream modulator may differ from the modulation imparted by the downstream modulator, and the optical upstream output signal may consequently be different from the optical downstream output signal.

The modulation performed by the upstream and downstream modulators may be light amplitude modulation. Alternatively, the modulation may be frequency modulation, phase modulation, polarization modulation or any combination of amplitude, frequency, phase and polarization modulation.

The upstream light sensor may be configured to generate an electric upstream control signal based on an optical upstream input signal. Conversely, the downstream light sensor may be configured to generate an electric downstream control signal based on an optical downstream input signal. Both the upstream and downstream light sensor may for example be semiconductor light sensors with a bandgap which is suitable for measuring the wavelength band utilized in the optical input signals. The light sensors may detect the intensity of the incoming light when they are being illuminated, and the sensors can be configured to convert the intensity sequence of the optical input signals into corresponding electric control signals. Alternatively or complementarily, the light sensors may detect the frequency and/or phase of the optical input signals and generate electric control signals from this information.

The upstream and downstream light sensors may be configured so that they can detect the kind of modulation which is present in the incoming optical signals. The repeater may optionally comprise more than one upstream light sensors for detecting the optical upstream input signal and generating the electric upstream control signal, and more than one downstream light sensors for detecting the optical downstream input signal and generating the electric downstream control signal. Multiple light sensors may be needed to deal with more complex modulation schemes and, e.g., polarization rotation.

The upstream modulator may be configured to retrieve the electric upstream control signal from the upstream light sensor. The optical carrier signal may be directed to the upstream modulator from the laser system with any suitable optical means. The upstream modulator may then generate an optical upstream output signal by modulating the optical carrier signal with the modulation provided by the electric upstream control signal. The optical upstream output signal can then be directed to the upstream fiber-optic output port with any suitable optical means.

Similarly, the downstream modulator may be configured to retrieve the electric downstream control signal from the downstream light sensor. The optical carrier signal may be directed to the downstream modulator from the laser system with any suitable optical means. The downstream modulator may then generate an optical downstream output signal by modulating the optical carrier signal with the modulation provided by the electric downstream control signal. The optical downstream output signal can then be directed to the downstream fibre-optic output port with any suitable optical means.

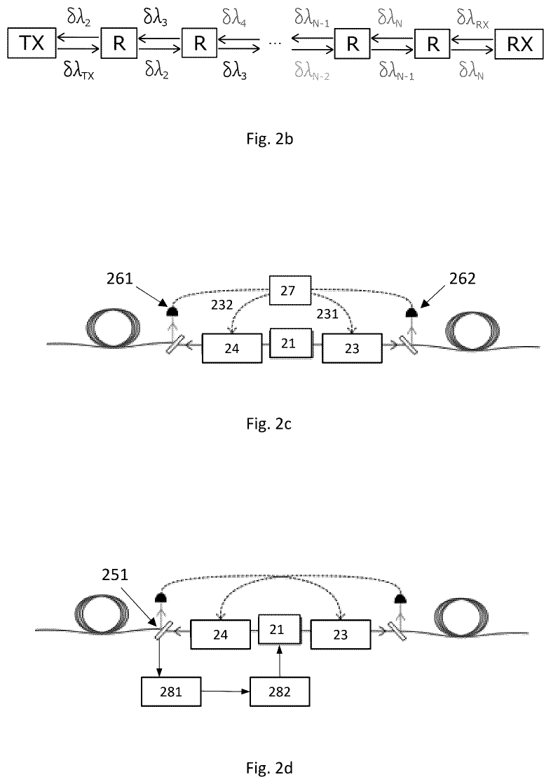

FIG. 2a illustrates a bidirectional optical signal repeater 29 which comprises an upstream light sensor 261. An optical upstream input signal 211 arrives at an upstream fibre-optic input port (not illustrated) and it may for example be guided toward the upstream light sensor 261 by an optional first beam splitter 251 and/or any other means for guiding an optical signal. An optional second beam splitter 252 may perform the same function on an optical downstream input signal 221.

The upstream light sensor 261 converts the signal 211 into an electric upstream control signal 231, and a downstream light sensor 262 converts the signal 221 into an electric downstream control signal 232. A single laser device 21 emits light without modulation. This light may be transmitted to both the upstream modulator 23 and the downstream modulator 24 for example with another beam splitter (not illustrated). The wavelength of the light which arrives at the upstream modulator 23 is the same as the wavelength of the light which arrives at the downstream modulator 24. This wavelength may be called the laser wavelength of the laser device 21, or the laser wavelength of the laser system. Any drift which occurs in the laser wavelength will be equal in the upstream and downstream directions.

The optical carrier signal is then modulated in both the upstream modulator 23 and in the downstream modulator 24 based on the upstream and downstream control signals 231 and 232, respectively. This produces the optical upstream and downstream output signals 212 and 222 which are transmitted through the fibre-optic link to the next optical signal repeater stations or to the transmitter/receiver station.

The benefit of using just one laser device 21 is that if the laser wavelength shifts due to temperature changes or ageing, the shift 8\ will always be the same in the upstream and downstream directions. FIG. 2b illustrates several optical signal repeaters R connected in series between a transmitter TX and a receiver RX. Each repeater R corresponds to the repeater 29 in FIG. 2a. If a wavelength shift 82 takes place in the upstream direction at repeater i, the wavelength shift which takes place in the downstream direction at that repeater necessarily has the same magnitude δλᵢ.

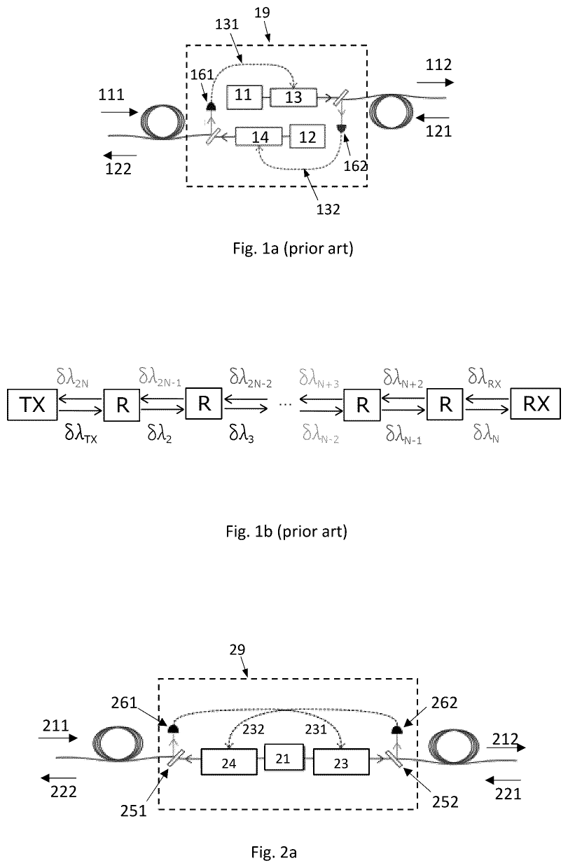

With certain reasonable approximations, the time variation at the receiver can be expressed as (see FIG. 1b):

$$\partial {t}_{R X} = \frac{D}{2} ( {L}_{N} \partial {λ}_{R X} - {L}_{1} \partial {λ}_{T X} + {\sum }_{i = 2}^{N} ( {L}_{i + N} \partial {λ}_{i + N} - {L}_{i} \partial {λ}_{i} ) ) ,$$

where D is the fiber dispersion, Lᵢ are the various fiber lengths between adjacent repeater stations and δλ_{TX}, δΔλ_{RX} and δλᵢ are the wavelength drifts at the transmitter, the receiver and the repeaters, respectively. When the wavelength drift is equal in both the upstream and downstream directions at each repeater station R, as in FIG. 2b, the expression reduces to:

$$\partial {t}_{R X} = \frac{D}{2} ( {L}_{N} \partial {λ}_{R X} - {L}_{1} \partial {λ}_{T X} + {\sum }_{i = 2}^{N} ( {L}_{i + N} - {L}_{i} ) \partial {λ}_{i} ) ,$$

which means that timing drift due to wavelength drift in the repeaters can be largely suppressed if the fiber lengths between adjacent repeater stations can be made approximately equal. These considerations apply to all embodiments presented in this disclosure.

FIG. 2c illustrates an embodiment where the upstream and downstream control signals 231 and 232 pass through a signal conditioning circuit 27 before being transmitted to the upstream and downstream modulators, respectively. The circuit 27 may for example perform functions such as amplification, thresholding, filtering and/or reshaping. This embodiment may be combined with any other embodiment presented in this disclosure.

In any embodiment of this disclosure, optical isolators may be placed between the upstream modulator and the second fibre-optic port and/or between the downstream modulator and the first fibre-optic port. Alternatively or complementarily, optical isolators may be placed between the laser and either or both of the modulators. Optical isolators prevent disturbances caused by light backscattering from the fibre which they are coupled to.

FIG. 2d illustrates an embodiment where the repeater comprises a wavelength locker 281 and a control circuit 282. A part of the laser light emitted by the laser 21 is directed to a wavelength locker 281 which is configured to stabilize the wavelength of the laser 21. The wavelength locker 281 may be coupled to a control circuit 282 which keeps the wavelength emitted by laser system constant, for example by controlling the laser current or temperature. In FIG. 2d a minor reflection is taken from beam splitter 251, but the beam pick-off for the wavelength locker 281 could alternatively be done anywhere else in the illustrated system. This embodiment may be combined with any other embodiment presented in this disclosure.

FIG. 2e illustrates an embodiment where the repeater also comprises one or more optical amplifiers 283 coupled to the laser system (in this case the single laser device 21), and the upstream modulator 23, or the downstream modulator 24, or both the upstream modulator and the downstream modulator, retrieve the optical carrier signal from the laser system through the one or more optical amplifier 283s. This embodiment may be combined with any other embodiment presented in this disclosure, including ones where the laser system comprises more than one laser device.

Instead of comprising a single laser device, the laser system may comprise a first laser device and a second laser device. The laser system should then also include an arrangement which ensures that the laser wavelength emitted by the first laser device is equal or essentially equal to the wavelength emitted by the second laser device, and especially that any drift which occurs in the laser wavelength will be equal in the upstream and downstream directions.

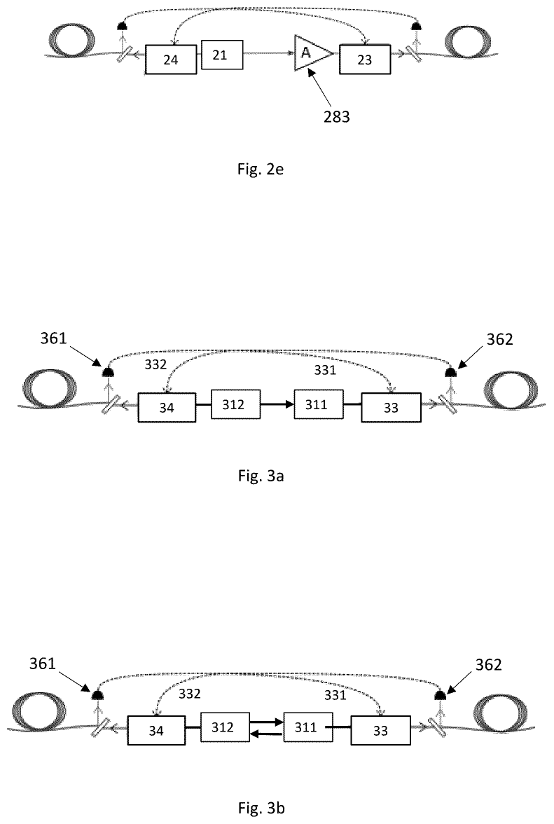

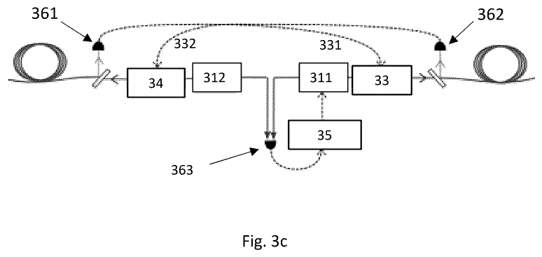

FIG. 3a illustrates a bidirectional optical signal repeater where reference numbers 33, 34, 331-332 and 361-362 correspond to reference numbers 23, 24, 231-232 and 261-262, respectively, in FIG. 2a. In this repeater the laser system comprises a first laser device 311 and a second laser device 312. The first laser device 311 is injection-locked to the second laser device 312. This one-directional locking is illustrated by the left-right arrow from 312 to 311. In practice, laser 312 is used to optically inject light into laser 311. When the injection power is suitable and the frequency difference between the two lasers before locking is sufficiently small, 311 will lock to the frequency of 312, so that the same wavelength will be emitted both upstream and downstream. The locking can alternatively be bi-directional. FIG. 3b illustrates a repeater where the left-right and right-left arrows between 311 and 312 indicate that the second laser device is also injection-locked to the first laser device.

Finally, the laser system may comprise a first laser device and a second laser device, and the first laser device may be frequency-locked to the second laser device. This option is illustrated in FIG. 3c, where the light emitted by a first laser device 311 and the light emitted by a second laser device 312 is directed to an additional photodetector 363, where they are measured simultaneously. The additional photodetector 363 is coupled to a control circuit 35. This control circuit may for example be configured to measure the frequency difference between the light emitted by the first laser device 311 and the light emitted by the second laser device 312. The control circuit 35 may be configured to adjust the current/temperature or some other control parameter of one of the lasers (the first laser device 311 in FIG. 3c) in order to keep their frequency drifts equal. A small wavelength difference (sufficiently small not to compromise the performance of the optical signal repeater) may in this case exist between the optical carrier signal produced by the first laser device and the optical carrier signal produced by the second laser device. The frequency-locking will keep this difference constant, so that neither laser device can undergo frequency drift independently of the other laser device.

In other words, the devices described in this disclosure keep the wavelength drift in the upstream direction equal to the wavelength drift in the downstream direction either ensuring that the modulators modulate the same optical carrier signal, or by ensuring that the modulated optical carrier signals are separated from each other only by a small and constant difference in wavelength.

In any embodiment in this disclosure, the laser device or laser devices in the laser system may be distributed-feedback lasers. In any embodiment, the upstream modulator and/or the downstream modulator may be an electro-absorption modulator or a Mach-Zehnder modulator.

This disclosure also relates to a method for repeating an optical signal. This method comprises the steps of:
generating an optical carrier signal with a laser system,
retrieving an optical upstream input signal from an upstream fibre-optic input port and converting it into an electric upstream modulation signal,
retrieving an optical downstream input signal from a downstream fibre-optic input port and converting it into an electric downstream modulation signal,
modulating the optical carrier signal with the electric upstream modulation signal to generate an optical upstream output signal, and transmitting the optical upstream output signal to an upstream fibre-optic output port.

The method also comprises the step of modulating the optical carrier signal with the electric downstream modulation signal to generate an optical downstream output signal, and transmitting the optical downstream output signal to a downstream fibre-optic output port.

Any of the device options discussed with reference to FIGS. 2a-2e or 3a-3c can be included as additional options also in this method for repeating an optical signal.

1. An optical signal repeater comprising
an upstream fibre-optic input port and an upstream light sensor coupled to the upstream fibre-optic input port,
a downstream fibre-optic input port and a downstream light sensor coupled to the downstream fibre-optic input port,
a laser system configured to generate an optical carrier signal,
an upstream modulator controlled by the upstream light sensor, wherein the upstream modulator is configured to generate an optical upstream output signal by modulating the optical carrier signal and to transmit the optical upstream output signal to an upstream fibre-optic output port,
characterized in that the optical signal repeater also comprises a downstream modulator which is controlled by the downstream light sensor, and that the downstream modulator is configured to generate an optical downstream output signal by modulating the optical carrier signal and to transmit the optical downstream output signal to a downstream fibre-optic output port.

2. The optical signal repeater according to claim 1, wherein the upstream fibre-optic input port is the same port as the downstream fibre-optic output port, and the downstream fibre-optic input port is the same port as the upstream fibre-optic output port.

3. The optical signal repeater according to claim 1, wherein the laser system comprises a single laser device.

4. The optical signal repeater according to claim 1, wherein the laser system comprises a first laser device and a second laser device, and the first laser device is injection-locked to the second laser device.

5. The optical signal repeater according to claim 4, wherein the second laser device is also injection-locked to the first laser device.

6. The optical signal repeater according to claim 1, wherein the laser system comprises a first laser device and a second laser device, and the first laser device is frequency-locked to the second laser device.

7. The optical signal repeater according to claim 1, further comprising one or more optical amplifiers coupled to the laser system, and wherein the upstream modulator and/or the downstream modulator retrieves the optical carrier signal from the laser system through the one or more optical amplifiers.

8. A method for repeating an optical signal, wherein the method comprises the steps of:
generating an optical carrier signal with a laser system,
retrieving an optical upstream input signal from an upstream fibre-optic input port and converting it into an electric upstream modulation signal,
retrieving an optical downstream input signal from a downstream fibre-optic input port and converting it into an electric downstream modulation signal,
modulating the optical carrier signal with the electric upstream modulation signal to generate an optical upstream output signal, and transmitting the optical upstream output signal to an upstream fibre-optic output port,
characterized in that the method also comprises the step of modulating the optical carrier signal with the electric downstream modulation signal to generate an optical downstream output signal and transmitting the optical downstream output signal to a downstream fibre-optic output port.

9. The method according to claim 8, wherein the upstream fibre-optic input port is the same port as the downstream fibre-optic output port, and the downstream fibre-optic input port is the same port as the upstream fibre-optic output port.
